(19) United States
(12) Patent Application Publication
(10) Pub. No.: US 2025/0239392 A1
(43) Pub. Date: Jul. 24, 2025

(54) SOLDERING STRUCTURE AND COIL COMPONENT

(71) Applicant: CYNTEC CO., LTD., Hsinchu (TW)

(72) Inventors: Chia-Cheng Chuang, Hsinchu (TW); Min-Feng Chung, Hsinchu (TW)

(73) Assignee: CYNTEC CO., LTD., Hsinchu (TW)

(21) Appl. No.: 19/032,416

(22) Filed: Jan. 20, 2025

Related U.S. Application Data
(60) Provisional application No. 63/624,288, filed on Jan. 24, 2024.

(51) Int. Cl. H01F 27/28; H01F 27/24

(52) U.S. Cl. CPC H01F 27/2823; H01F 27/24

(57) ABSTRACT

A soldering structure includes a conductive base, a conductive wire and a soldering portion. The conductive base includes a first limiting member and a second limiting member spaced apart from the first limiting member. The conductive wire includes a conductive portion and an insulating layer covering the conductive portion. The conductive portion includes an exposed portion exposed from the insulating layer, the conductive wire passes through the first limiting member, the exposed portion is located between the first limiting member and the second limiting member, and the second limiting member clamps an end of the conductive wire. The soldering portion at least partially covers the exposed portion, the first limiting member and the second limiting member, so that the conductive wire is electrically connected with the conductive base.

### CROSS REFERENCE TO RELATED APPLICATIONS

This application claims the benefit of U.S. Provisional Application No. 63/624, 288, filed on Jan. 24, 2024. The content of the application is incorporated herein by reference.

### BACKGROUND OF THE INVENTION

### 1. Field of the Invention

The present disclosure relates to a soldering structure and a coil component, and more particularly, to a soldering structure with an enhanced reliability and a coil component having the same.

### 2. Description of the Related Art

Soldering is a process of connecting two metal surfaces together by a solder. In the process of soldering, the solder can be placed of the two metal surfaces to be connected and is heated to melt. When the melted solder is cool and solidifies, a solder joint is formed between the two metal surfaces to connect the two metal surfaces. The soldering is widely used in the electronics industry. For example, the soldering can be used to connect conductive wires of a circuit, to connect electronic components to a printed circuit board (PCB), etc.

However, a soldering structure usually has a weaker structural strength at the solder joint. For example, when the soldering is used to connect a conductive wire to a metal surface, the conductive wire may be damaged during stripping off the insulating layer thereof, or the conductive wire may be pulled back and forth due to the thermal expansion and contraction of another component connected with the conductive wire, which may cause the breakage of the conductive wire at or close to the solder joint. Therefore, how to improve the soldering structure to enhance the reliability thereof has become a goal of relevant industries.

### SUMMARY OF THE INVENTION

According to an embodiment of the present disclosure, a soldering structure includes a conductive base, a conductive wire and a soldering portion. The conductive base includes a first limiting member and a second limiting member spaced apart from the first limiting member. The conductive wire includes a conductive portion and an insulating layer covering the conductive portion. The conductive portion includes an exposed portion exposed from the insulating layer, the conductive wire passes through the first limiting member, the exposed portion is located between the first limiting member and the second limiting member, and the second limiting member clamps an end of the conductive wire. The soldering portion at least partially covers the exposed portion, the first limiting member and the second limiting member, so that the conductive wire is electrically connected with the conductive base.

According to another embodiment of the present disclosure, a coil component includes a core member, a conductive base, a conductive wire and a soldering portion. The conductive base is disposed on the core member. The conductive base includes a first limiting member and a second limiting member spaced apart from the first limiting member. The conductive wire winds around the core member. The conductive wire includes a conductive portion and an insulating layer covering the conductive portion. The conductive portion includes an exposed portion exposed from the insulating layer. The conductive wire passes through the first limiting member, the exposed portion is located between the first limiting member and the second limiting member, and the second limiting member clamps an end of the conductive wire. The soldering portion at least partially covers the exposed portion, the first limiting member and the second limiting member, so that the conductive wire is electrically connected with the conductive base.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a three-dimensional diagram showing a coil component according to an embodiment of the present disclosure.

FIG. 2 is another three-dimensional diagram of the coil component in FIG. 1.

FIG. 3 is a three-dimensional diagram of the coil component in FIG. 1 with a plate member being omitted.

FIG. 4 is a partially enlarged view of the coil component in FIG. 3.

FIG. 5 is a partial plan view of the coil component in FIG. 1.

FIG. 6 is a cross-sectional view taken along line A-A′ in FIG. 5.

FIG. 7 is a partial side view of a coil component according to another embodiment of the present disclosure.

FIG. 8 is a partial side view of a coil component according to yet another embodiment of the present disclosure.

### DETAILED DESCRIPTION

In the following detailed description of the embodiments, reference is made to the accompanying drawings which form a part thereof, and in which is shown by way of illustration specific embodiments in which the disclosure may be practiced. In this regard, directional terminology, such as up, down, left, right, front, back, bottom or top is used with reference to the orientation of the Figure(s) being described. The elements of the present disclosure can be positioned in a number of different orientations. As such, the directional terminology is used for purposes of illustration and is in no way limiting. In addition, identical numeral references or similar numeral references are used for identical elements or similar elements in the following embodiments.

Hereinafter, for the description of “the first feature is formed on or above the second feature”, it may refer that “the first feature is in contact with the second feature directly”, or it may refer that “there is another feature between the first feature and the second feature”, such that the first feature is not in contact with the second feature directly.

It is understood that, although the terms first, second, etc. may be used herein to describe various elements, regions, layers and/or sections, these elements, regions, layers and/or sections should not be limited by these terms. These terms may be only used to distinguish one element, region, layer and/or section from another element, region, layer and/or section. Terms such as “first,” “second,” and other numerical terms when used herein do not imply a sequence or order unless clearly indicated by the context. Thus, a first element, region, layer and/or section discussed below could be termed a second element, region, layer and/or section without departing from the teachings of the embodiments. The terms used in the claims may not be identical with the terms used in the specification, but may be used according to the order of the elements claimed in the claims.

In the present disclosure, the following drawings are described in conjunction with the XYZ Cartesian coordinate system for the sake of convenience.

In the present disclosure, the term “electrically connected”, “electrically contact” or “coupled to” includes means of direct or indirect electrical connection.

It should be understood that according to the following embodiments, features of different embodiments may be replaced, recombined or mixed to constitute other embodiments without departing from the spirit of the present disclosure. The features of various embodiments may be mixed arbitrarily and used in different embodiments without departing from the spirit of the present disclosure or conflicting.

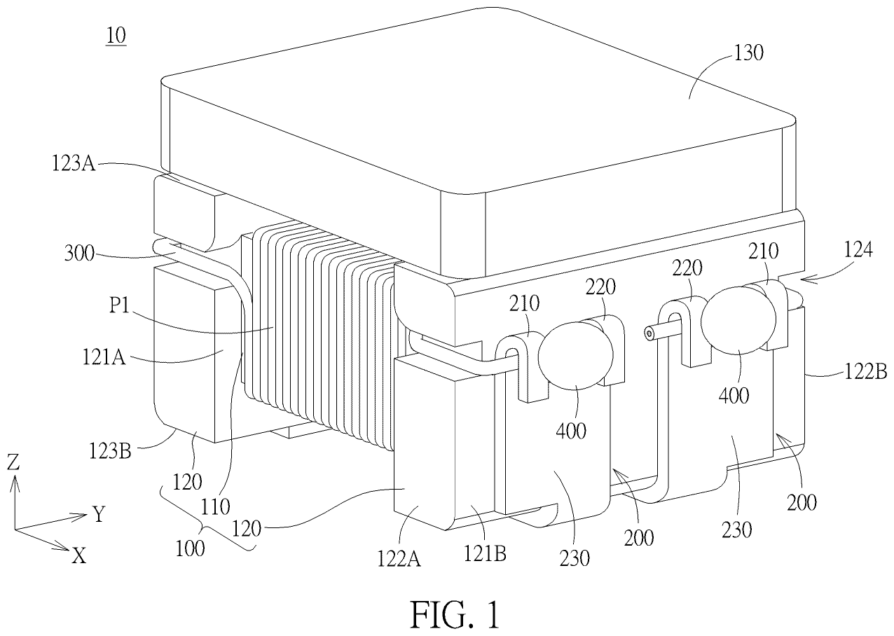

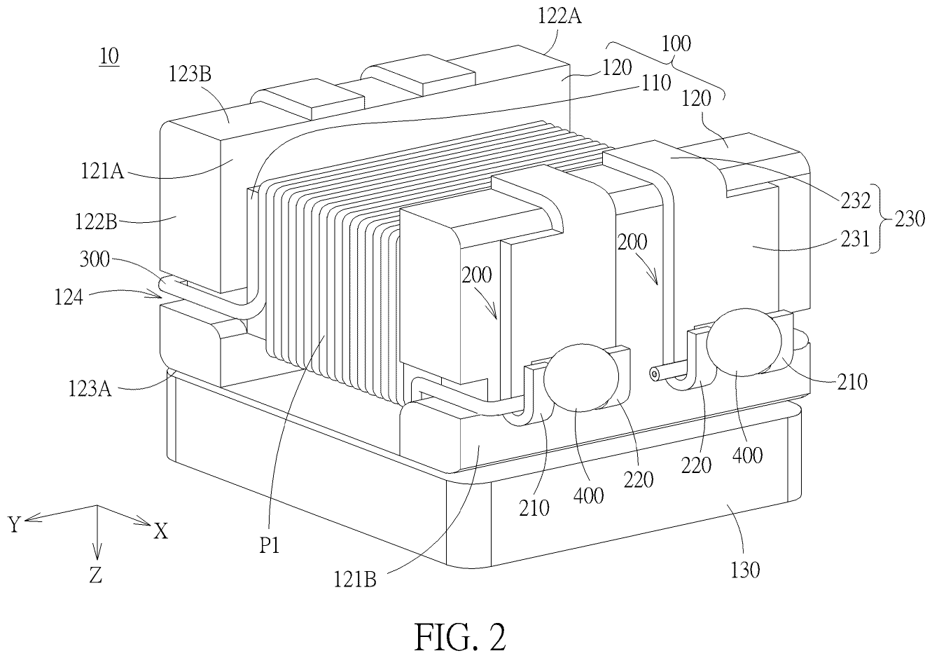

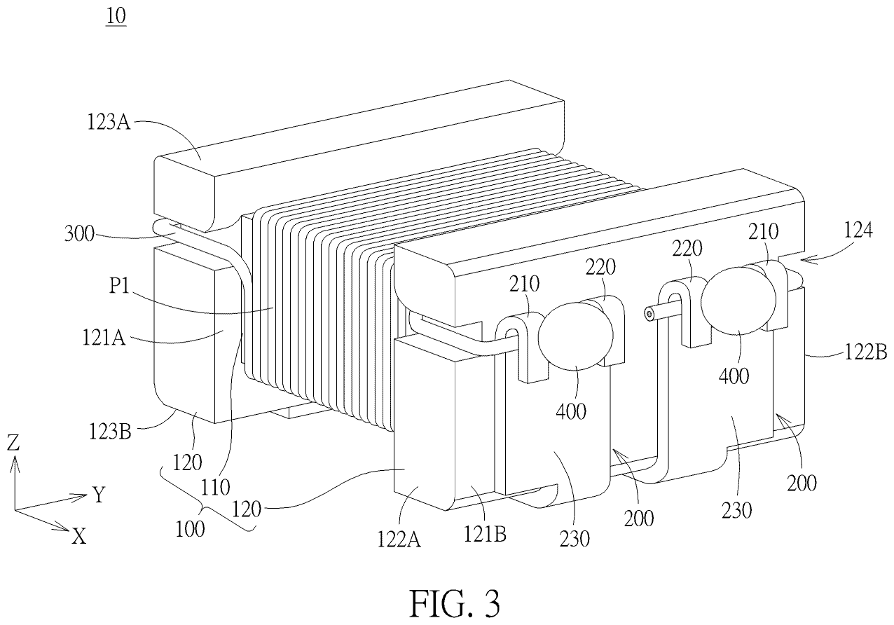

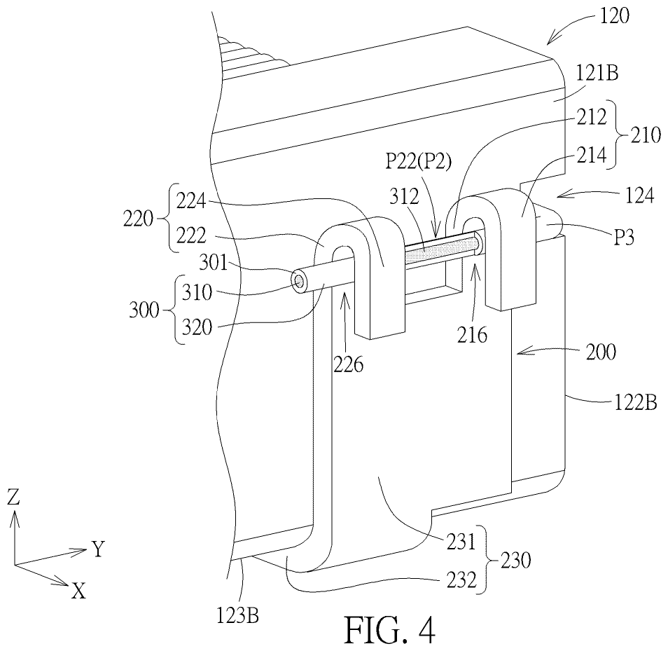

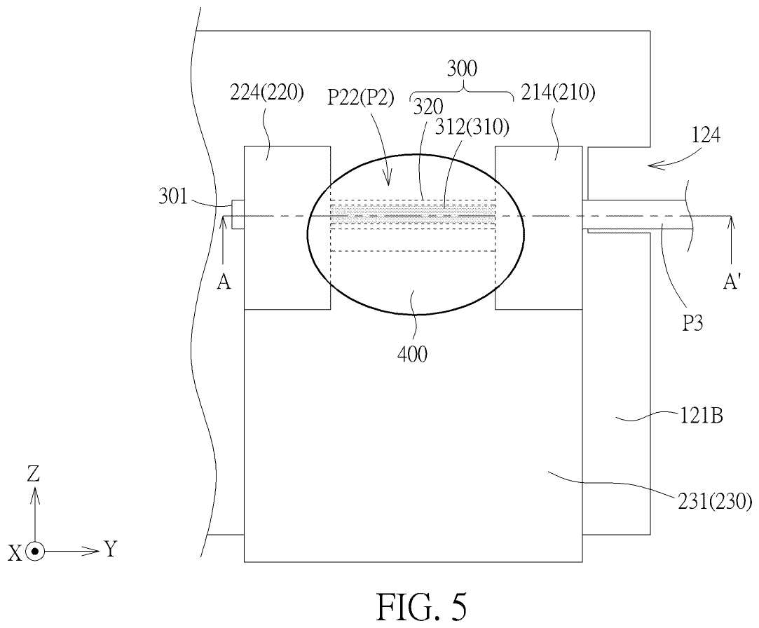

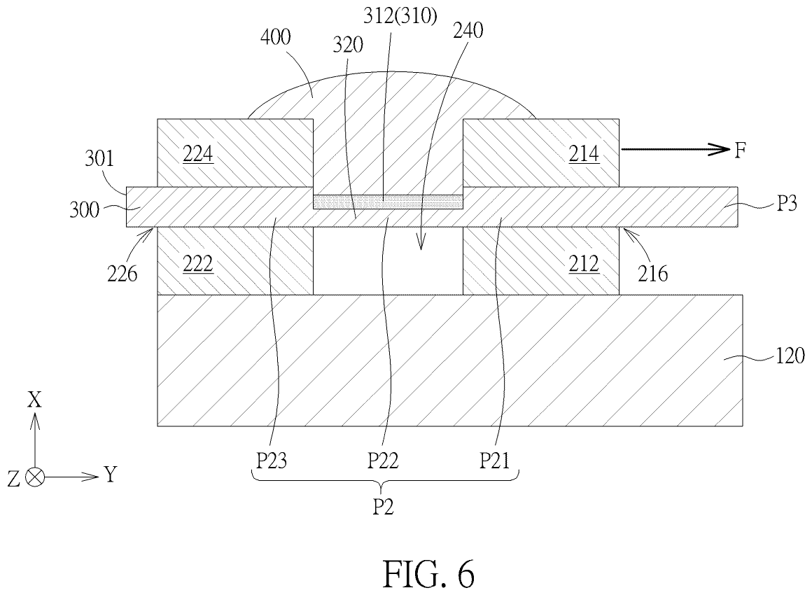

Please refer to FIG. 1 to FIG. 6. FIG. 1 is a three-dimensional diagram showing a coil component 10 according to an embodiment of the present disclosure. FIG. 2 is another three-dimensional diagram of the coil component 10 in FIG. 1. FIG. 3 is a three-dimensional diagram of the coil component 10 in FIG. 1 with a plate member 130 is omitted. FIG. 4 is a partially enlarged view of the coil component 10 in FIG. 1, in which a soldering portion 400 in FIG. 1 is omitted for clearly showing the connection relationship between a conductive base 200 and a conductive wire 300. FIG. 5 is a partial plan view of the coil component 10 in FIG. 1, which mainly shows the connection relationship between the conductive base 200, the conductive wire 300 and the soldering portion 400. FIG. 6 is a cross-sectional view taken along line A-A′ in FIG. 5, which mainly shows the connection relationship between the conductive base 200, the conductive wire 300 and the soldering portion 400. The coil component 10 includes a core member 100, the conductive base 200, the conductive wire 300 and the soldering portion 400. The coil component 10 may be applied as an inductor, such as a common mode choke (CMC), but not limited thereto.

The core member 100 may include a wound portion 110 and two flange portions 120. The wound portion 110 may define an axial direction (herein, the direction X). The two flange portions 120 are respectively disposed at two ends of the wound portion 110 in the axial direction. The two flange portions 120 protrude outward relative to the wound portion 110 in a direction perpendicular to the axial direction (such as the direction on the X-Y plane). Therefore, a projection of the wound portion 110 on a plane (herein, the X-Y plane) perpendicular to the axial direction is within a projection of each of the flange portions 120 on the plane perpendicular to the axial direction.

Each of the flange portions 120 includes an inner surface 121A, an outer surface 121B and side surfaces 122A, 122B, 123A, 123B connected between the inner surface 121A and the outer surface 121B. The inner surface 121A and the outer surface 121B are disposed opposite to each other in the axial direction. The inner surface 121A faces the wound portion 110, and the outer surface 121B faces away from the wound portion 110. The side surfaces 122A and 122B are disposed opposite to each other in a first direction (herein, the direction Y) perpendicular to the axial direction, the side surfaces 123A and 123B are disposed opposite to each other in a second direction (herein, the direction Z) perpendicular to the axial direction, and the first direction may be perpendicular to the second direction. The two flange portions 120 may be integrally formed with the wound portion 110.

The core member 100 may be made of a magnetically permeable material, such as ferrite. The coil component 10 may optionally further include a plate member 130 disposed along the axial direction on the side surfaces 123A of the two flange portions 120. Thereby, the core member 100 and the plate member 130 together form a closed magnetic circuit.

The conductive wire 300 winds around the core member 100. The conductive wire 300 includes a conductive portion 310 and an insulating layer 320 covering the conductive portion 310. The material of the conductive portion 310 may include a metal, such as copper, silver, aluminum or a combination thereof. The material of the insulating layer 320 may include resin, such as polyurethane, polyester, polyamide-imide (PAI) or a combination thereof. In some embodiments, the conductive wire 300 may be a magnet wire (also called enameled wire).

The number of the conductive wires 300 is exemplarily two. The two conductive wires 300 are magnetically coupled to each other but electrically insulated from each other. A middle portion P1 of each of the conductive wires 300 winds around the wound portion 110 of the core member 100, and two end portions P2 of each of the conductive wires 300 are respectively disposed on the two outer surfaces 121B of the two flange portions 120, so that the coil component 10 is a four-terminal component. In some embodiments, the two conductive wires 300 may wind around the wound portion 110 symmetrically, and the number of turns of the two conductive wires 300 on the wound portion 110 may be the same. The flange portion 120 may be formed with a groove 124 on each of the side surfaces 122A and 122B for accommodating the conductive wire 300. Thereby, the conductive wires 300 do not protrude from the side surfaces 122A and 122B of the flange portions 120, which is beneficial to reduce the overall volume of the coil component 10 and reduce the probability of interference between the coil component 10 and other components when assembling the coil component 10.

The conductive base 200 is disposed on the core member 100. The conductive base 200 may serve as a terminal electrode of the coil component 10. The conductive base 200 may exemplarily be a lead frame. The number of the conductive bases 200 may be flexibly adjusted according to the number of the conductive wires 300. Herein, the number of the conductive bases 200 is four. The four conductive bases 200 are respectively configured to electrically connect with the four end portions P2 of the two conductive wires 300. Two of the four conductive bases 200 may be symmetrically disposed on one of the flange portions 120 and spaced apart from each other. The other two of the four conductive bases 200 may be symmetrically disposed on the other one of the flange portions 120 and spaced apart from each other.

The conductive base 200 may include a main body 230, a first limiting member 210 and a second limiting member 220. The main body 230 is connected with the first limiting member 210 and the second limiting member 220. The first limiting member 210 and the second limiting member 220 may be integrally formed with the main body 230. The main body 230 may include a first sheet body 231 and a second sheet body 232. The first sheet body 231 is disposed on the outer surface 121B, the second sheet body 232 is disposed on the side surface 123B, and the second sheet body 232 is bent relative to the first sheet body 231. Herein, the second sheet body 232 is perpendicularly bent relative to the first sheet body 231, but not limited thereto. The shape of the main body 230 may be adjusted according to actual needs. The coil component 10 may be electrically connected to other components such as a printed circuit board (PCB) through the second sheet body 232.

As shown in FIG. 4 to FIG. 6, the second limiting member 220 is spaced apart from the first limiting member 210. The conductive portion 310 includes an exposed portion 312 at the end portion P2 of the conductive wire 300. The exposed portion 312 is not covered by the insulating layer 320 and exposed from the insulating layer 320. The conductive wire 300 passes through the first limiting member 210, the exposed portion 312 is located between the first limiting member 210 and the second limiting member 220, and the second limiting member 220 clamps an end of the conductive wire 300. The soldering portion 400 at least partially covers the exposed portion 312, the first limiting portion 210 and the second limiting portion 220, so that the conductive wire 300 is electrically connected with the conductive base 200. Thereby, the conductive wire 300 may be electrically connected to other components such as a printed circuit board through the conductive base 200.

Specifically, the end portion P2 of the conductive wire 300 may include a first sub-portion P21, a second sub-portion P22 and a third sub-portion P23 (see FIG. 6). The first sub-portion P21 passes through the first limiting member 210, the third sub-portion P23 is clamped by the second limiting portion 220, the second sub-portion P22 is located between the first sub-portion P21 and the third sub-portion P23, and the exposed portion 312 is located in the second sub-portion P22. The third sub-portion P23 may include a terminal end 301 of the end portion P2 of the conductive wire 300 or the third sub-portion P23 is closest to the terminal end 301 of the end portion P2 among the first sub-portion P21, the second sub-portion P22 and the third sub-portion P23. The aforementioned “the third sub-portion P23 may include a terminal end 301 of the end portion P2 of the conductive wire 300” may refer that the terminal end 301 of the conductive wire 300 is clamped by the second limiting member 220. The aforementioned “the third sub-portion P23 is closest to the terminal end 301 of the end portion P2” may refer that the terminal end 301 is not clamped by the second limiting member 220 but is located at a side of the second limiting member 220 away from the second sub-portion P22. In other words, the aforementioned “the second limiting member 220 clamps an end of the conductive wire 300” may refer that the second limiting member 220 clamps the terminal end 301 of the conductive wire 300, or the second limiting member 220 clamps a portion of the conductive wire 300 adjacent to the terminal end 301 of the conductive wire 300. The conductive wire 300 may further include a connecting portion P3 connected between the end portion P2 and the middle portion P1.

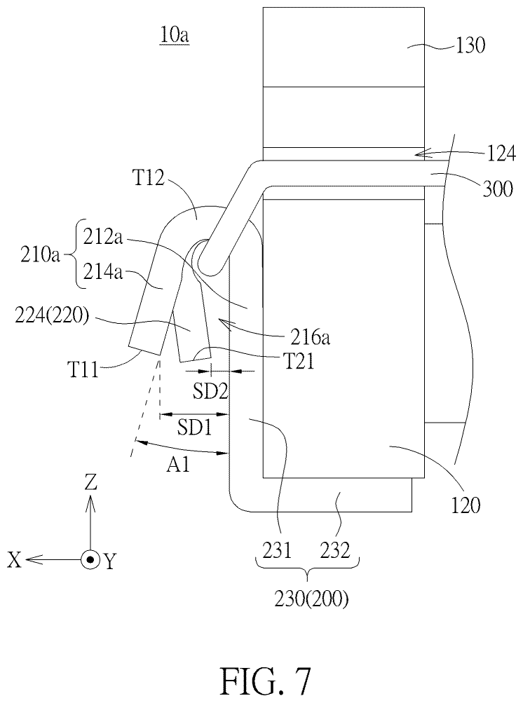

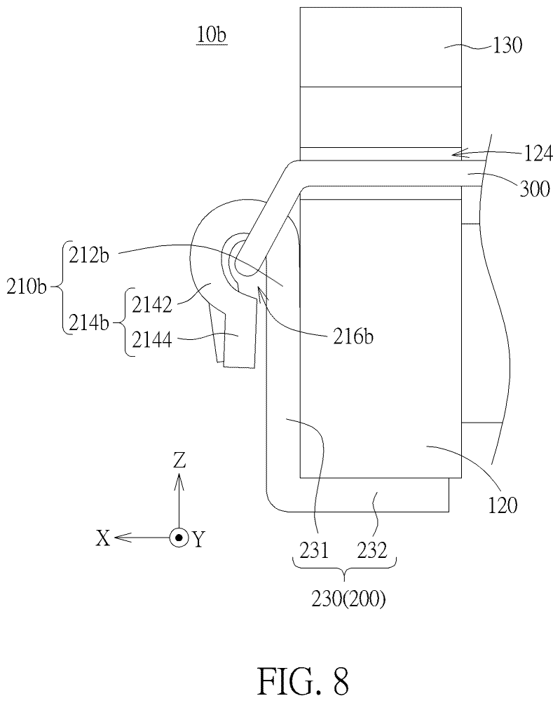

The first limiting member 210 may include a first extending portion 212 and a first covering portion 214. The first extending portion 212 extends from the main body 230, and the first covering portion 214 extends from the first extending portion 212 toward the main body 230. A first space 216 is defined between the first extending portion 212 and the first covering portion 214 of the first limiting member 210 for accommodating the first sub-portion P21 of the conductive wire 300. In other words, the first sub-portion P21 may be covered by the first covering portion 214 without being exposed. In this embodiment, the first extending portion 212 and the first covering portion 214 together form a clip structure, which can be configured to clamp and fix the first sub-portion P21 of the conductive wire 300. Thereby, the effect for assisting the second limiting member 220 to clamp and fix the conductive wire 300 can be provide, but not limited to thereto. In some embodiments, the first extending portion 212 and the first covering portion 214 may only be configured to provide the first space 216 to accommodate the first sub-portion P21 of the conductive wire 300 but not clamp the first sub-portion P21 of the conductive wire 300. For this part, references may be made to relevant descriptions of FIG. 7 and FIG. 8. In other words, before the soldering portion 400 is formed, the effect of clamping and fixing the conductive wire 300 is mainly provided by the second limiting member 220.

The second limiting member 220 may include a second extending portion 222 and a second covering portion 224. The second extending portion 222 extends from the main body 230, and the second covering portion 224 extends from the second extending portion 222 toward the main body 230. A second space 226 is defined between the second extending portion 222 and the second covering portion 224 of the second limiting member 220 for accommodating the third sub-portion P23 of the conductive wire 300. In other words, the third sub-portion P23 may be covered by the second covering portion 224 without being exposed. The second extending portion 222 and the second covering portion 224 together form a clip structure for clamping and fixing the third sub-portion P23 of the conductive wire 300. The second limiting member 220 is configured to fix the conductive wire 300 during the soldering process.

When manufacturing the coil component 10, the wound portion 110 may be wound around by the conductive wire 300 first, then one end portion P2 of the conductive wire 300 is passed through the groove 124 formed on the flange portion 120, and then the first sub-portion P21 of the conductive wire 300 is passed through the first limiting member 210, and the third sub-portion P23 is clamped by the second limiting member 220. In this embodiment, the first sub-portion P21 is also clamped by the first limiting member 210.

Next, a laser stripping process may be performed to remove a portion of the insulating layer 320 in the second sub-portion P22 of the conductive wire 300, i.e., the portion of the insulating layer 320 is irradiated by the laser (not shown), so that the exposed portion 312 is formed. The exposed portion 312 is located between the first limiting member 210 and the second limiting member 220, and is located on a side of the conductive wire 300 facing outward (i.e., the side facing away from the flange portion 120). Next, a soldering process may be performed to form the soldering portion 400. For example, a solder material (not shown) may be covered on the exposed portion 312, and then a laser soldering process or a reflow soldering process is performed to melt the solder material, so that the melted solder material can at least partially cover the exposed portion 312, the first limiting member 210 and the second limiting member 220. After the melted solder material is cool and solidifies, the soldering portion 400 at least partially covers the exposed portion 312, the first limiting member 210 and the second limiting member 220 can be obtained. According to an embodiment, the solder material may include tin. That is, a material of the soldering portion 400 may include tin.

As shown in FIG. 5 and FIG. 6, the soldering portion 400 may completely cover the exposed portion 312. Thereby, the stability of the electrical connection between the soldering portion 400 and the exposed portion 312 can be improved. The soldering portion 400 may also partially cover the main body 230. Thereby, it is beneficially for the soldering portion 400 to be evenly disposed between the first limiting portion 210, the second limiting portion 220 and the main body 230, and the stability of the electrical connection between the soldering portion 400 and the exposed portion 312 can be further improved.

As shown in FIG. 6, the soldering portion 400 may be separated from the first extending portion 212 and the second extending portion 222. Specifically, a space 240 is defined between the first extending portion 212 and the second extending portion 222, and the soldering portion 400 is not disposed in the space 240. If the space 240 is filled with the solder material, a cavity may be formed in the solder material after the reflow soldering process. If there is moisture in the cavity, the cavity may burst in another reflow soldering process for assembling the coil component 10 on another component such as a printed circuit board (PCB). As a result, the solder material may splash all around, which may cause contamination and short circuit. Therefore, with the soldering portion 400 not being disposed in the space 240, it is favorable for reducing the probabilities of contamination and short circuit caused by the splash of the solder material.

In the present disclosure, with the conductive base 200 including the first limiting member 210 and the second limiting member 220, the following advantages may be provided. First, the exposed portion 312 can be limited between the first limiting member 210 and the second limiting member 220, which is beneficial to maintain the structural strength of the connecting portion P3. Specifically, the first covering portion 214 of the first limiting member 210 and the second covering portion 224 of the second limiting member 220 respectively cover the first sub-portion P21 and the third sub-portion P23 of the conductive wire 300. When removing the insulating layer 320 of the second sub-portion P22 with the laser, the first covering portion 214 and the second covering portion 224 can protect the first sub-portion P21 and the third sub-portion P23 from being irradiated by the laser. Therefore, the exposed portion 312 can be limited between the first limiting member 210 and the second limiting member 220, which is beneficial to maintain the structural strength of portions other than the second sub-portion P22. For example, the structural strength of the connecting portion P3 immediately adjacent to the first sub-portion P21 can be maintained. Thereby, the probability that the connecting portion P3 is broken when the conductive wire 300 is pulled by an external force F (see FIG. 6) can be reduced. For example, the connecting portion P3 may be pulled back and forth by the core member 100 due to thermal expansion and contraction of the core member 100.

Moreover, since the exposed portion 312 is located between the first limiting member 210 and the second limiting member 220, the portion that the soldering portion 400 connected with the exposed portion 312 is also located between the first limiting member 210 and the second limiting member 220. As shown in FIG. 6, when the conductive wire 300 is pulled by the external force F (which may be generated by the thermal expansion and contraction of the core member 100), the external force F is transmitted to the first limiting member 210 and can be prevented by the first limiting member 210 from further transmitting to the portion (i.e., the second sub-portion P22) between the first limiting member 210 and the second limiting member 220. Thereby, the influence of the external force F on the electrical connection relationship between the soldering portion 400 and the exposed portion 312 can be reduced.

Furthermore, in the present disclosure, when forming the soldering portion 400, the melted solder material simultaneously covers the first limiting member 210 and the second limiting member 220. During the cooling and solidification process of the melted solder material, the soldering portion 400 is not easy to shrink toward a single limiting member, which is beneficial to maintain the width (herein, the length of the soldering portion 400 in the direction Y) of the soldering portion 400. Thereby, the coverage degree of the soldering portion 400 on the exposed portion 312 can be enhanced. When the soldering portion 400 is required to be melted again, the width of the remelted soldering portion 400 can also be maintained since the soldering portion 400 simultaneously covers the first limiting member 210 and the second limiting member 220, and the coverage degree of the remelted soldering portion 400 on the exposed portion 312 can also be maintained.

Compared with a conductive base that is only disposed with a single limiting member. That is, a conductive base is only disposed with the second limiting member 220 to fix the conductive wire 300 during the soldering process. The connecting portion P3 of the conductive wire 300 is immediately adjacent to the exposed portion 312. When forming the exposed portion 312, due to the limitation of the focusing accuracy of the laser, the connecting portion P3 is also be damaged by the irradiation of the laser. As a result, the structural strength of the connecting portion P3 is weakened. When the conductive wire 300 is pulled by an external force (which may be generated by the thermal expansion and contraction of the core member 100), the breakage tends to occur at the connecting portion P3. Furthermore, when the conductive wire 300 is pulled by the external force, due to the lack of the protection of the first limiting member 210, the external force will directly act on the soldering portion 400 and the exposed portion 312, which may result in the separation of the soldering portion 400 and the exposed portion 312.

In addition, for the conductive base only disposed with the second limiting member 220 but not disposed with the first limiting member 210, when forming the soldering portion 400, during the cooling and solidification process of the melted solder material, the melted solder material is affected by the second limiting member 220 and shrinks toward the second limiting member 220. As a result, the soldering portion 400 concentrates at the second limiting member 220, so that the coverage area of the soldering portion 400 on the exposed portion 312 is reduced. In some examples, the soldering portion 400 even does not cover the exposed portion 312. That is, the electrical connection between the soldering portion 400 and the exposed portion 312 cannot be formed.

In other words, in the present disclosure, with the conductive base 200 including both the first limiting member 210 and the second limiting member 220, it is beneficial to maintain the structural strength of the connecting portion P3, and it is beneficial to improve the stability of the electrical connection between the soldering portion 400 and the exposed portion 312. As a result, the coil component 10 has an enhanced reliability.

Please refer to FIG. 7, which is a partial side view of a coil component 10a according to another embodiment of the present disclosure. The main difference between the coil component 10a and the coil component 10 is that the structure of the first limiting member 210a is different from the structure of the first limiting member 210.

In FIG. 7, a terminal end T21 of the second covering portion 224 of the second limiting member 220 is arranged to get close to the main body 230, so that the second limiting member 220 may provide the function of clamping and fixing the conductive wire 300 during the soldering process. A terminal end T11 of the first covering portion 214a of the first limiting member 210a is arranged to get away from the main body 230. Specifically, the first covering portion 214a has the terminal end T11 and a connecting end T12 connected to the first extending portion 212a. The terminal end T11 is further away from the first extending portion 212a than the connecting end T12. Thereby, the first limiting member 210a only provides the first space 216a to accommodate the first sub-portion P21 (see FIG. 6) of the conductive wire 300 without clamping the first sub-portion P21 of the conductive wire 300. Therefore, it can prevent the first sub-portion P21 from being clamped by the first limiting member 210a, and can prevent the tensile strength of the first sub-portion P21 from being reduced. Thereby, the reliability of the coil component 10a can be further improved.

A first distance SD1 is between the first extending portion 212a and the first covering portion 214a, a second distance SD2 is between the second extending portion 222 (see FIG. 4) and the second covering portion 224, and the first distance SD1 may be greater than the second distance SD2. The aforementioned first distance SD1 may refer to the minimum distance in the direction X between the terminal end T11 of the first covering portion 214a and the first extending part 212a. The aforementioned second distance SD2 may refer to the minimum distance in the direction X between the terminal end T21 of the second covering portion 224 and the second extending portion 222. The direction X may be, for example, parallel to the normal direction (not shown) of the outer surface of the first sheet body 231. An included angle Al is between the first extending portion 212a and the first covering portion 214a, and the included angle Al may be greater than or equal to 5 degrees and less than or equal to 60 degrees.

Please refer to FIG. 8, which is a partial side view of a coil component 10b according to yet another embodiment of the present disclosure. The main difference between the coil component 10b and the coil component 10 is that the structure of the first limiting member 210b is different from the structure of the first limiting member 210. In this embodiment, the first space 216b defined between the first extending portion 212b and the first covering portion 214b of the first limiting member 210b is an curved space, and the shape of the first space 216b may be arranged according to the shape of the conductive wire 300, so that the first limiting member 210b only provides the first space 216b to accommodate the first sub-portion P21 (see FIG. 6) of the conductive wire 300 without clamping the first sub-portion P21 of the conductive wire 300. Therefore, it can prevent the first sub-portion P21 from being clamped by the first limiting member 210b, and can prevent the tensile strength of the first sub-portion P21 from being reduced. Thereby, the reliability of the coil component 10b can be further improved.

As shown in FIG. 8, the first covering portion 214b includes a curved segment 2142 corresponding to the curved space and an end segment 2144 connected with the curved segment 2142, and the end segment 2144 is parallel to the first extending portion 212b. The aforementioned “the end segment 2144 being parallel to the first extending portion 212b” may include the end segment 2144 being parallel to or substantially parallel to the first extending portion 212b. Specifically, the end segment 2144 defines a first extending direction (i.e., parallel to the length direction thereof), the first extending portion 212b defines a second extending direction (i.e., parallel to the length direction thereof). An included angle between the first extending direction of the end segment 2144 and the second extending direction of the first extending portion 212b may be within the range of 0 degrees plus or minus 10 degrees or within the range of 180 degrees plus or minus 10 degrees.

Please refer to FIG. 1 to FIG. 6. The present disclosure further provides a soldering structure (not labeled). The soldering structure includes the conductive base 200, the conductive wire 300 and the soldering portion 400. The conductive base 200 includes the first limiting member 210 and the second limiting member 220. The second limiting member 220 is spaced apart from the first limiting member 210. The conductive wire 300 includes the conductive portion 310 and the insulating layer 320 covering the conductive portion 310. The conductive portion 310 includes the exposed portion 312 exposed from the insulating layer 320. The conductive wire 300 passes through the first limiting member 210, the exposed portion 312 is located between the first limiting member 210 and the second limiting member 220, and the second limiting member 220 clamps the end of the conductive wire 300. The soldering portion 400 at least partially covers the exposed portion 312, the first limiting member 210 and the second limiting member 220, so that the conductive wire 300 is electrically connected with the conductive base 200. With the conductive base 200 including both the first limiting member 210 and the second limiting member 220, the reliability of the soldering structure can be improved. For details about the soldering structure, references may be made to the relevant description above and are omitted herein. In some embodiments, the first limiting member 210 may be replaced by the first limiting member 210a shown in FIG. 7. In some embodiments, the first limiting member 210 may be replaced by the first limiting member 210b shown in FIG. 8.

In the embodiments shown in FIG. 1 to FIG. 8, the soldering structures are applied to the coil components 10, 10a, and 10b. However, it is only exemplary, and the present disclosure is not limited thereto. The soldering structure according to the present disclosure can be applied to other types of electronic components. With the soldering structure with an improved reliability, when the electronic component includes the soldering structure according to the present disclosure, the electronic component can also have an improved reliability.

Compared with the prior art, in the present disclosure, with the conductive base including both the first limiting member and the second limiting member, it is beneficial to limit the exposed portion of the conductive wire between the first limiting member and the second limiting member, which is beneficial to maintain the structural strength of the connecting portion immediately adjacent to the first limiting member, and the influence of external forces on the electrical connection relationship between the soldering portion and the exposed portion can be reduced. Moreover, in the present disclosure, with the soldering portion at least partially covering the exposed portion, the first limiting member and the second limiting member, it can prevent the soldering portion from shrinking toward a single limiting member, which is beneficial to enhance the coverage degree of the soldering portion on the exposed portion. Thereby, the soldering structure according to the present disclosure can have an enhanced reliability.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A soldering structure, comprising:
a conductive base, comprising:
a first limiting member; and
a second limiting member spaced apart from the first limiting member;
a conductive wire comprising a conductive portion and an insulating layer covering the conductive portion, wherein the conductive portion comprises an exposed portion exposed from the insulating layer, the conductive wire passes through the first limiting member, the exposed portion is located between the first limiting member and the second limiting member, and the second limiting member clamps an end of the conductive wire; and
a soldering portion at least partially covering the exposed portion, the first limiting member and the second limiting member, so that the conductive wire is electrically connected with the conductive base.

2. The soldering structure of claim 1, wherein the soldering portion completely covers the exposed portion.

3. The soldering structure of claim 1, wherein the first limiting member clamps the conductive wire.

4. The soldering structure of claim 1, wherein the conductive base further comprises a main body connected with the first limiting member and the second limiting member.

5. The soldering structure of claim 4, wherein the soldering portion further partially covers the main body.

6. The soldering structure of claim 4, wherein the first limiting member and the second limiting member are integrally formed with the main body.

7. The soldering structure of claim 4, wherein the first limiting member comprises a first extending portion extending from the main body and a first covering portion extending from the first extending portion toward the main body, and the second limiting member comprises a second extending portion extending from the main body and a second covering portion extending from the second extending portion toward the main body.

8. The soldering structure of claim 7, wherein the soldering portion is separated from the first extending portion and the second extending portion.

9. The soldering structure of claim 8, wherein a space is defined between the first extending portion and the second extending portion, and the soldering portion is not disposed in the space.

10. The soldering structure of claim 7, wherein a first distance is between the first extending portion and the first covering portion, a second distance is between the second extending portion and the second covering portion, and the first distance is greater than the second distance.

11. The soldering structure of claim 7, wherein an included angle is between the first extending portion and the first covering portion, and the included angle is greater than or equal to 5 degrees and less than or equal to 60 degrees.

12. The soldering structure of claim 7, wherein a curved space for accommodating the conductive wire is defined between the first extending portion and the first covering portion.

13. The soldering structure of claim 12, wherein the first covering portion comprises a curved segment corresponding to the curved space and an end segment connected with the curved segment, and the end segment is parallel to the first extending portion.

14. The soldering structure of claim 1, wherein a material of the conductive portion comprises copper, and a material of the soldering portion comprises tin.

15. A coil component, comprising:
a core member;
a conductive base disposed on the core member, wherein the conductive base comprises a first limiting member and a second limiting member spaced apart from the first limiting member;
a conductive wire winding around the core member, wherein the conductive wire comprises a conductive portion and an insulating layer covering the conductive portion, the conductive portion comprises an exposed portion exposed from the insulating layer, the conductive wire passes through the first limiting member, the exposed portion is located between the first limiting member and the second limiting member, and the second limiting member clamps an end of the conductive wire; and
a soldering portion at least partially covering the exposed portion, the first limiting member and the second limiting member, so that the conductive wire is electrically connected with the conductive base.

16. The coil component of claim 15, wherein the core member is made of a magnetically permeable material.

17. The coil component of claim 15, wherein the first limiting member clamps the conductive wire.

18. The coil component of claim 15, wherein the conductive base further comprises a main body, the first limiting member comprises a first extending portion extending from the main body and a first covering portion extending from the first extending portion toward the main body, and the second limiting member comprises a second extending portion extending from the main body and a second covering portion extending from the second extending portion toward the main body.

19. The coil component of claim 18, wherein a first distance is between the first extending portion and the first covering portion, a second distance is between the second extending portion and the second covering portion, and the first distance is greater than the second distance.

20. The coil component of claim 18, wherein a curved space for accommodating the conductive wire is defined between the first extending portion and the first covering portion.
